(19) United States
(12) Patent Application Publication
(10) Pub. No.: US 2007/0253149 A1
(43) Pub. Date: Nov. 1, 2007

(54) UNIVERSAL HARNESS AND ELECTRONICS SYSTEM

(76) Inventor: Michael E. Mohn, Monroe, MI (US)

Correspondence Address: HARNESS, DICKEY & PIERCE, P.L.C., P.O. BOX 828, BLOOMFIELD HILLS, MI, 48303, US

(21) Appl. No.: 11/740,532

(22) Filed: Apr. 26, 2007

Related U.S. Application Data
(60) Provisional application No. 60/795,228, filed on Apr. 26, 2006.

(51) Int. Cl. H02B 1/00

(52) U.S. Cl. 361/600

(57) ABSTRACT

An electronics system for furniture includes at least one accessory module. A hand control module is operable to receive a plurality of face plates. Each of the plurality of face plates includes at least one interface device that controls the at least one accessory module. The hand control module outputs a control signal based in part on which of the plurality of face plates is connected to the hand control module. A control module is operable to connect to a plurality of accessory modules, receives the control signal, and outputs an accessory control signal to the at least one accessory module based on the control signal and based on which of the plurality of accessory modules is connected to the control module.

### FIELD OF THE INVENTION

The present invention relates to electrical systems for articles of furniture, and more particularly to an electrical system that is adaptable to provide control to multiple accessory configurations.

### BACKGROUND OF THE INVENTION

Articles of furniture, including, but not limited to, sofas, chairs, and/or reclining chairs, may include one or more electrical (i.e. power-assisted) components. For example, an article of furniture may include at least one of a vibratory massage system, an air massage system, a heat pad system, and power motors (i.e. motors for recline, leg rest, and/or lift functions).

Typically a chair having one or more electrical components includes an electrical wiring or harness system. The electrical system may include a power supply such as a transformer, a hand control wand, and/or various accessory control devices. The power supply provides power from an electrical receptacle to the electrical components. The hand control wand allows user control of the electrical components.

### SUMMARY OF THE INVENTION

An electronics system for furniture comprises at least one accessory module. A hand control module is operable to receive a plurality of face plates, wherein each of the plurality of face plates includes at least one interface device that controls the at least one accessory module and the hand control module outputs a control signal based in part on which of the plurality of face plates is connected to the hand control module. A control module is operable to connect to a plurality of accessory modules, receives the control signal, and outputs an accessory control signal to the at least one accessory module based on the control signal and based on which of the plurality of accessory modules is connected to the control module.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of an electronics system for an article of furniture according to the present invention;

FIG. 2 is a functional block diagram of a control module and hand control wand according to the present invention;

FIG. 3 is a functional block diagram of a hand control wand including multiple face plate attachments according to the present invention;

FIG. 4A is a functional block diagram of a first configuration of a control module and a massage system according to the present invention; and

FIG. 4B is a functional block diagram of a second configuration of a control module and a lift system according to the present invention.

### DETAILED DESCRIPTION OF THE PREFERRED EMBODIMENTS

The following description is merely exemplary in nature and is in no way intended to limit the disclosure, its application, or uses. For purposes of clarity, the same reference numbers will be used in the drawings to identify similar elements. As used herein, the term module, circuit and/or device refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

The present invention is directed to a universal electronics system for an article of furniture. The universal electronics system provides power and control to a plurality of functions, including, but not limited to, multiple massage systems, heat pad systems, lift systems, recline systems, and leg rest systems. In particular, the universal electronics system is adaptable to provide the above functions to one or more articles of furniture that support multiple combinations of the functions.

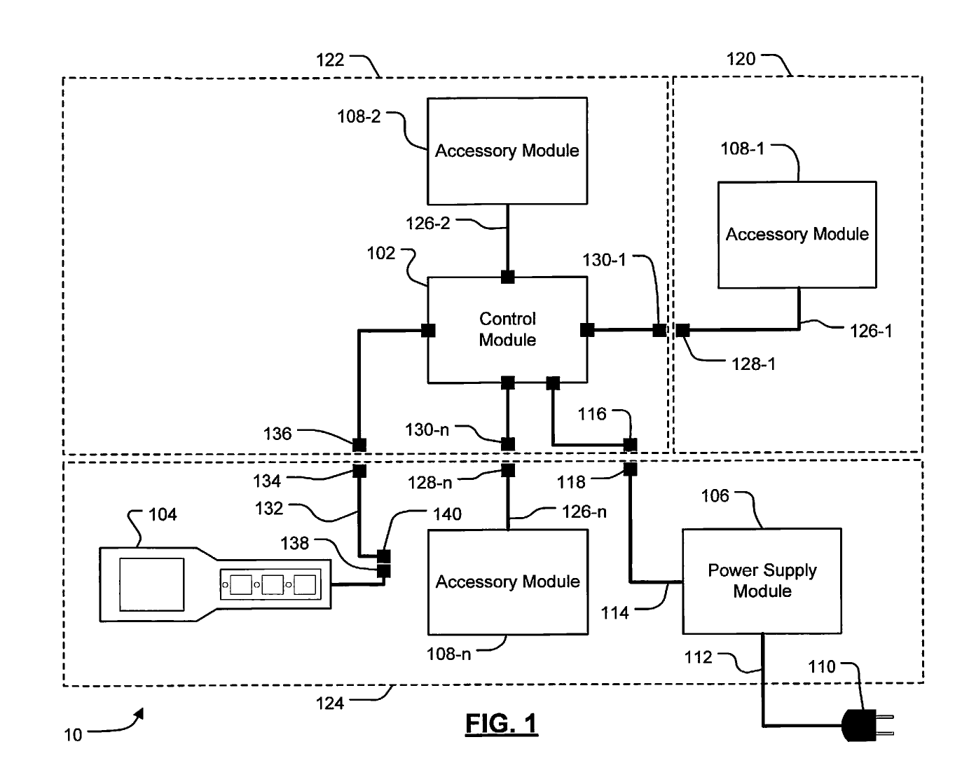

Referring now to FIG. 1, a universal electronics system 100 includes a control module 102, a hand control module or control wand 104, a power supply module 106, and accessory modules 108-1, 108-2, . . . , and 108-n, referred to collectively as accessory modules 108. The universal electronics system 100 is implemented in an article of furniture such as a reclining chair (not shown).

The power supply module 106 provides power to the universal electronics system 100. The power supply module 106 may include a plug attachment 110 that receives electrical power from an electrical receptacle. For example, the plug attachment 110 may include a two-prong attachment plug or a three-prong grounding plug attachment that fits into a grounding-type receptacle. The plug attachment 110 includes an insulated cable or power cord 112 of suitable length.

The power supply module 106 may implement or be implemented by a transformer. The power supply module 106 receives AC power from the receptacle via the power cord 112. The power supply module 106 steps down the input power, for example 120 volts of AC, to an output power. In an exemplary embodiment, the power supply module 106 outputs an AC voltage of 12 volts and a constant DC voltage of 27 volts. The power supply module 106 may include batteries (e.g. 9 volt batteries) that provide backup power to the universal electronics system 100 in the event of a power failure.

The control module 102 receives electrical power from the power supply module 106 via an electrical harness 114. The electrical harness 114 includes electrical plug and socket connectors 116 and 118, respectively. The connectors 116 and 118 allow the power supply module 106 and the control module 102 to be insertably attached and/or detached.

The control module 102 distributes the power from the power supply module 106 to the control wand 104 and the accessory modules 108. Further, the control module 102 controls functions of the accessory modules 108 based on commands received from the control wand 104. For example, the control module 102 includes a processor or microcontroller and a memory that stores control data. The control module 102 outputs control signals to the accessory modules 108 based on the control data and the commands from the control wand. 104.

The accessory modules 108 each provide specific functions, including, but not limited to, massage, heat, lift, recline, and leg rest functions. Further, each of the accessory modules 108 (as well as the control module 102, the control wand 104, and/or the power supply module 106) may be located in a different region of the chair. For example, the accessory module 108-1 may provide heat and/or massage functions and be located in a seat 120 of the chair. The accessory module 108-2 may provide heat andlor massage functions and be located in a back 122 of the chair with the control module 102. The accessory module 108-n may provide motor actuating functions (such as lift, recline, and leg rest functions) and be located in a base 124 of the chair with the control wand 104 and the power supply module 106.

The accessory modules 108 are connected to the control module 102 via accessory harnesses 126-1, 126-2, . . . , and 126-n, referred to collectively as accessory harnesses 126. The accessory harnesses 126 include plug connectors 128-1, . . . , and 128-n, referred to collectively as plug connectors 128, and socket connectors 130-1, . . . , and 130-n, referred to collectively as socket connectors 130. In the present implementation, the plug and socket connectors 128 and 130 are located near boundaries of respective regions of the chair. For example, the socket connectors 130 are located near boundaries of the back 122 of the chair. Similarly, the plug connectors 128-1 and 128-n are located near boundaries of the seat 120 and base 124. In this manner, interchangeability of the accessory modules 108 is facilitated.

The control wand 104 is connected to the control module 102 via a control harness 132. The control harness 132 includes plug and socket connectors 134 and 136. The plug and socket connectors 134 and 136 are located near boundaries of the base 124 and back 122, respectively. The control harness 132 also includes plug and socket connectors 138 and 140. For example, the plug and socket connectors 138 and 140 are located at or near an exterior of the base 124 to allow a user to attach and/or detach (e.g. to replace) the control wand 104. The control wand 104 may be mounted to a side arm of the chair or, alternatively, held and operated by a person using the chair.

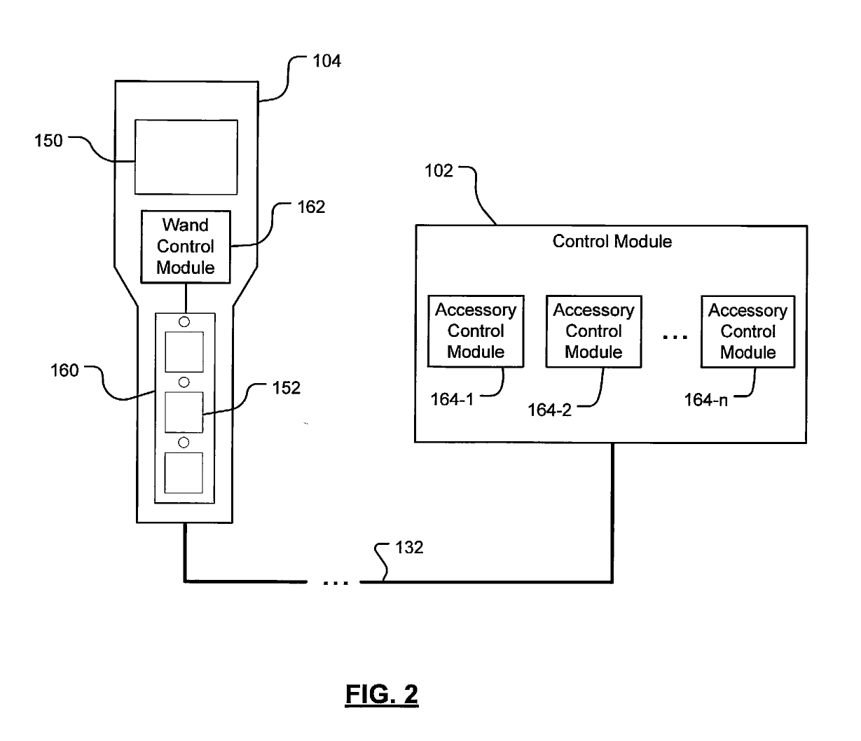

Referring now to FIG. 2, the control harness 132 provides electrical power to the control wand 104 from the control module 102 and communicates commands from the control wand 104 to the control module 102. The control wand 104 may include indicator means 150, such as an LED array, and one or more interface devices such as control switches 152. The user may control the various functions of the chair with the switches 152, such as lifting and lowering functions, reclining functions, and “on,” “off,” or “intensity” statuses of heating or massage systems. For example, when the user operates the switches 152 to lift the chair, electrical power is supplied to a motor actuator (not shown) cause the chair to lift. When the user operates the switches 152 to lower the chair, electrical power is supplied to the motor actuator to lower the chair. A more detailed description of an exemplary implementation of a lift system for a chair is disclosed in U.S. patent application Ser. No. 10/964,286, filed Apr. 13, 2004, which is hereby incorporated by reference in its entirety.

The user may view status information for the chair at the indicator means 150, such as “on” or “off” status of massage systems or relative temperature indicators of heating systems. For example, the control module 102 may receive feedback data from the accessory modules 108 such as temperature, lift position, and/or massage intensity. The control module 102 communicates the feedback data to the control wand 104 to be displayed with the indicator means 150.

The control wand 104 includes a face plate attachment 160 that includes the switches 152. The face plate attachment 160 communicates with a wand control module 162. The wand control module 162, for example, includes a processor or microcontroller and a memory. The memory stores control data related to functions of the chair. When the user interacts with the one or more of the switches 152, the wand control module 162 determines which of the switches 152 the user actuated and communicates corresponding control data to the control module 102. For example, the control wand 104 and the control module 102 may communicate via a 3-wire serial communications interface.

The control module 102 may include various accessory control modules 164-1, 164-2, . . . , and 164-n, referred to collectively as accessory control modules 164. When the control module 102 receives the control data from the control wand 104 based on user interaction, the control module 102 directs an appropriate command to a corresponding accessory control module 164. For example, the accessory control modules 164-1, 164-2, . . . , and 164-n may correspond to massage, heat, and lift functions, respectively. When the control module 102 receives control data related to massage functions, the control data is directed to the accessory control module 164-1. The accessory control module 164-1 outputs a command to the corresponding accessory module 108 as shown in FIG. 1.

In the present implementation, the control module 102 includes accessory control modules to control all potential functions of a chair that implements the universal electronics system 100. For example, a first chair that provides lift and recline functions includes the control module 102. A second chair that provides lift, recline, and massage functions includes the control module 102. A third chair that provides only massage functions includes the control module 102. In other words, the control module 102 includes accessory control modules that correspond to all potential functions to accommodate multiple chair configurations. For example, the control module 102 includes an accessory control module for a massage system regardless of whether the chair provides a massage function. In this manner, the universal electronics system 100, and more specifically the control module 102 and the control wand 104, is adaptable to be used with all possible chair configurations.

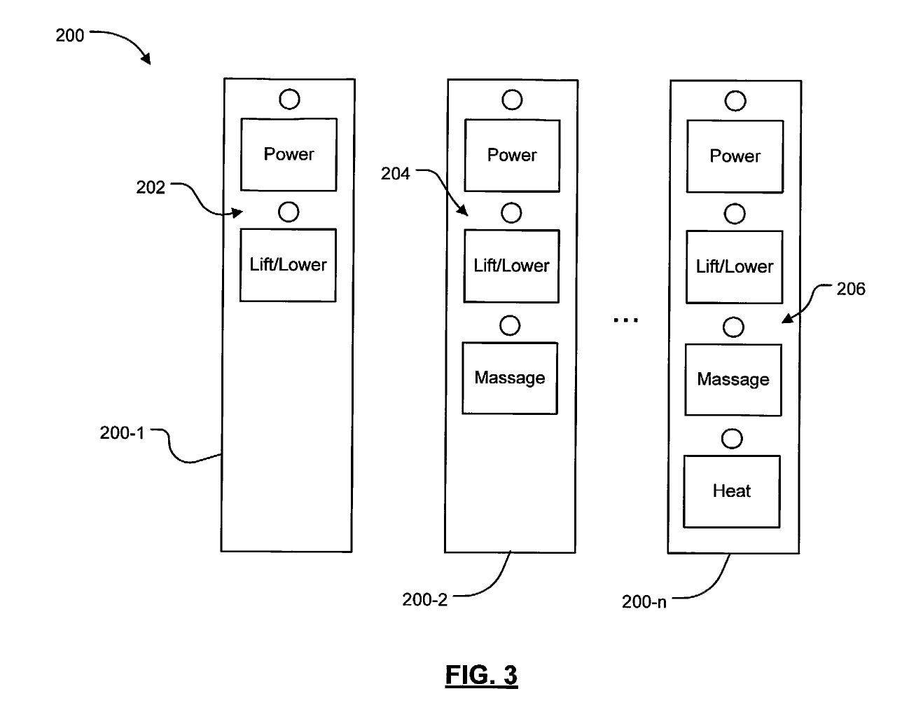

Referring now to FIG. 3, face plate attachments 200 of the control wand 104 are interchangeable. For example, the control wand 104 is operable to receive and communicate with multiple face plate attachments 200-1, 200-2, . . . , and 200-n, referred to collectively as face plate attachments 200. A first face plate attachment 200-1 may include switches 202 to control power on/off and lift functions. A second face plate attachment 200-2 may include switches 204 to control power on/off, lift, and massage functions. An nth face plate attachment 200-n may include switches 206 to control power on/off, lift, massage, and heat functions.

In the present implementation, the wand control module 162 is configured to communicate with each of the face plate attachments 200. For example, when a particular chair includes only a lift function, the universal electronics system 100 includes the control module 102, the control wand 104, and the face plate attachment 200-1. When the chair includes lift and massage functions, the universal electronics system 100 includes the control module 102, the control wand 104, and the face plate attachment 200-2. When the chair includes lift, massage, and heat functions, the universal electronics system 100 includes the control module 102, the control wand 104, and the face plate attachment 200-n. In other words, regardless of the functions that a particular chair provides, the universal electronics system 100 includes a standard control module 102 and control wand 104 that each provide control and power management capabilities for any possible chair configuration. User control of the various functions of the chair is achieved by providing an appropriate one of the face plate attachments 200.

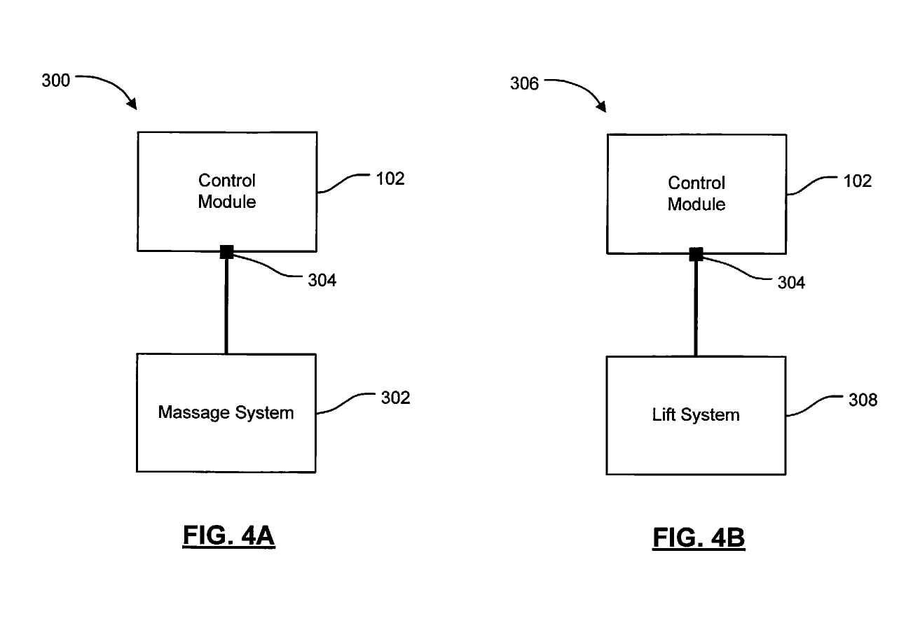

Referring now to FIGS. 4A and 4B, the control module 102 is operable to determine the functions that a particular chair provides. For example, in a first configuration 300 as shown in FIG. 4A, the chair may include a massage system 302 connected to the control module 102 via a connector 304. In a second configuration 306 as shown in FIG. 4B, the chair may include a lift system 308 connected to the control module 102 via the connector 304. Typically, different functions may have different power requirements (i.e. the massage function may require a first voltage and the lift function may require a second voltage). When the chair includes the lift system 308, the control module 102 detects the lift function and operates accordingly (i.e. outputs the second voltage). When the chair includes the massage system 302, the control module 102 detects the massage function and outputs the first voltage. In this manner, the control module 102 is operable to automatically control the various accessory modules based on the configuration of a particular chair.

In another implementation, the power supply module 106 as shown in FIG. 1 is interchangeable. For example, power requirements of a particular chair may vary according to configuration. Typically, lift functions require different power input than massage functions. The power supply module 106 may be varied according to which accessory modules the chair includes.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronics system for furniture, comprising:
at least one accessory module;
a hand control module that is operable to receive a plurality of face plates, wherein each of the plurality of face plates includes at least one interface device that controls the at least one accessory module and the hand control module outputs a control signal based in part on which of the plurality of face plates is connected to the hand control module; and
a control module that is operable to connect to a plurality of accessory modules, that receives the control signal, and that outputs an accessory control signal to the at least one accessory module based on the control signal and based on which of the plurality of accessory modules is connected to the control module.
